(19) United States
(12) Patent Application Publication
(10) Pub. No.: US 2009/0132935 A1
(43) Pub. Date: May 21, 2009

(54) VIDEO TAG GAME

(75) Inventor: Roelof VAN ZWOL, Badalona (ES)

Correspondence Address: YAHOO C/O MOFO PALO ALTO, 755 PAGE MILL ROAD, PALO ALTO, CA, 94304, US

(73) Assignee: Yahoo! Inc., Sunnyvale, CA (US)

(21) Appl. No.: 11/941,038

(22) Filed: Nov. 15, 2007

(51) Int. Cl. G06F 15/16; G06F 3/048

(52) U.S. Cl. 715/756

(57) ABSTRACT

A computer-enabled method is provided for labeling at least one portion of a video with one or more tags. The method includes causing the video to be displayed to at least two users, including a first user and a second user, receiving a first tag from the first user at a first time, receiving a second tag from the second user at a second time, determining a time difference between the first and second times, associating the first tag with the video, and providing a first consideration to the first user in response to the first tag matching the second tag and the time difference being less than a predetermined value, wherein the first consideration is based upon the time difference. The first and second considerations may be inversely proportional to the time difference and may be points or other compensation.

### BACKGROUND

1. Field

The present application relates generally to association of metadata with video, and more specifically to games for associating metadata with video.

2. Related Art

Metadata tagging of media objects is known in the art. For example, photographs may be annotated with labels or tags using a game known as the ESP game. The ESP game displays a photograph to two players, and allows the players to type labels for 2 minutes and 30 seconds. If both players type the same label, they receive points and a new photograph is displayed. The labels provided by the users may be used as image annotations, which are useful for image search and retrieval. The Flickr® web site allows users to annotate images with tags. In the video domain, web sites such as YouTube®, Jumpcut®, and Yahoo!® Video allow users to annotate videos with keywords and comments. Specialized applications, such as Viddler, and Motionbox™, allow users to tag parts of a video. However, these applications and video sites do not provide incentive for the user to provide accurate tags. It would be desirable, therefore, to be able to motivate users of web sites to provide accurate tags for videos.

### SUMMARY

In general, in a first aspect, the invention features a computer-enabled method of labeling at least one portion of a video. The method includes causing the video to be displayed to at least two users, including a first user and a second user, receiving a first tag from the first user, wherein the first tag is received at a first time, receiving a second tag from the second user, wherein the second tag is received at a second time, determining a time difference between the first time and the second time, associating the first tag with the video, and providing a first consideration to the first user in response to the first tag matching the second tag and the time difference being less than a predetermined value, wherein the first consideration is based upon the time difference.

Embodiments of the invention may include one or more of the following features. Associating the first tag with the video may include storing an association among the video, the first tag, and the first time. The method may further include associating the second tag with the video. The first consideration may include a first quantity of units of value, where the first quantity is based upon the time difference. Providing the first consideration may include increasing a score associated with the first user by a quantity of points, where the quantity is based upon the time difference. The first consideration may be inversely proportional to the time difference.

The method may further include providing a second consideration to the second user in response to the first tag matching the second tag and the time difference being less than the predetermined value, wherein the second consideration is based upon the time difference. The second consideration may be inversely proportional to the time difference.

The method may further include enforcing a tag repeat interval, wherein the first quantity is not provided to the first user if the first tag has been received from the first user at a previous time and the difference between the first time and the previous time is less than the tag repeat interval. Causing the video to be displayed may include causing the video to be displayed substantially continuously for a predetermined period of time.

The video may include an advertisement, and the method may further include determining a user perception of the advertisement in response to the first tag matching the second tag and the time difference being less than the predetermined value, wherein the user perception is based upon the first tag. The user perception may further be based upon the time difference.

In general, in a second aspect, the invention features a computer-enabled method of labeling at least one portion of a video. The method includes causing the video to be displayed to a user, wherein the video is associated with at least one predetermined tag, receiving a first tag from the user, wherein the first tag is received at a first time, selecting a second tag from the at least one predetermined tag, wherein the second tag matches the first tag, the second tag is associated with a second time, determining a time difference between the first time and the second time, associating the first tag with the video, and providing a first consideration to the user in response to the time difference being less than a predetermined value, wherein the consideration is based upon the time difference.

In general, in a third aspect, the invention features an interface for labeling at least one portion of a video. The interface includes a video display component for displaying the video, where the video is received from a server, a tag entry component for receiving a tag, where the interface is operable to transmit the tag to the server, and a score display component for displaying a score received from the server, where the score is associated with the user, the score is based upon at least the at least one tag and a timestamp associated with the at least one tag, and the timestamp indicates a time of receipt of the at least one tag.

In general, in a fourth aspect, the invention features a computer readable medium comprising instructions for labeling at least one portion of a video. The instructions are for causing the video to be displayed to at least two users, including a first user and a second user, receiving at least two tags from the at least two users, including a first tag and a second tag, wherein the first tag is received at a first time, and the second tag is received at a second time, determining a time difference between the first time and the second time, associating the at least two tags with the video, and providing a first consideration to the first user in response to the first tag matching the second tag and the time difference being less than a predetermined value, wherein the first consideration is based upon the time difference.

Embodiments of the invention may include one or more of the following features. Associating the at least two tags with the video may include storing associations between the video, the first tag, and the first time, and between the video, the second tag, and the second time. The first consideration may include a first quantity of units of value, and the first quantity may be based upon the time difference. The first consideration may be inversely proportional to the time difference. The instructions may further include providing a second consideration to the second user in response to the first tag matching the second tag and the time difference being less than the predetermined value, where the second consideration is based upon the time difference.

In general, in a fifth aspect, the invention features an apparatus for labeling at least one portion of a video, wherein the apparatus is located at a server on a network. The apparatus includes logic for causing the video to be displayed to at least two users, including a first user and a second user, logic for receiving a first tag from the first user, wherein the first tag is received at a first time, logic for receiving a second tag from the second user, wherein the second tag is received at a second time, logic for determining a time difference between the first time and the second time, logic for associating the first tag with the video; and logic for providing a first consideration to the first user in response to the first tag matching the second tag and the time difference being less than a predetermined value, wherein the first consideration is based upon the time difference.

Embodiments of the invention may include one or more of the following features. Associating the first tag with the video may include storing an association among the video, the first tag, and the first time. The apparatus may further include logic for associating the second tag with the video. The first consideration may include a first quantity of units of value, and the first quantity may be based upon the time difference. The logic for providing the first consideration may be operable to increase a score associated with the first user by a quantity of points, where the quantity is based upon the time difference. The first consideration may be inversely proportional to the time difference.

### BRIEF DESCRIPTION OF THE DRAWINGS

The present application can be best understood by reference to the following description taken in conjunction with the accompanying drawing figures, in which like parts may be referred to by like numerals:

FIG. 1 illustrates clients and servers that provide a video tag game in accordance with embodiments of the invention.

FIG. 2 illustrates allocation of points to players in response to receipt of tags for a video in accordance with embodiments of the invention.

FIG. 3 illustrates a video tag game user interface in accordance with embodiments of the invention.

FIGS. 4A and 4B illustrate data structures for use in a video tag game in accordance with embodiments of the invention.

FIG. 5 illustrates a process for allocating points to users in response to receipt of tags in accordance with embodiments of the invention.

FIG. 6 illustrates a process for allocating points to a user in response to receipt of a tag from the user in accordance with embodiments of the invention.

FIG. 7 illustrates a process for allocating points to a user in response to receipt of a tag from another user in accordance with embodiments of the invention.

FIG. 8 illustrates a typical computing system 800 that may be employed to implement processing functionality in embodiments of the invention.

### DETAILED DESCRIPTION

The following description is presented to enable a person of ordinary skill in the art to make and use the invention, and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

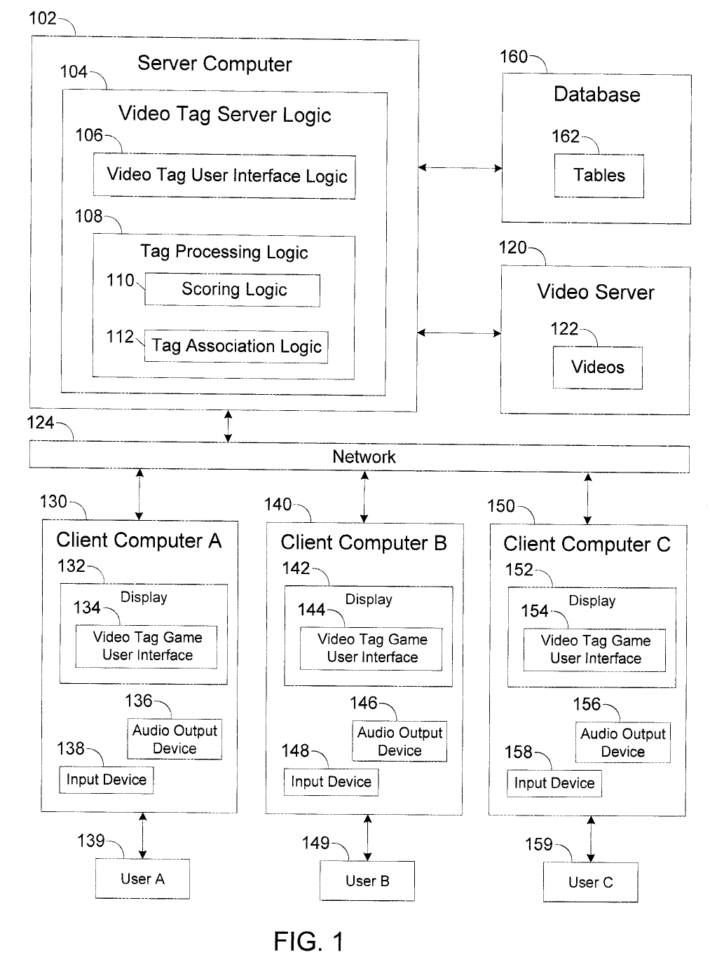

FIG. 1 illustrates clients and servers that provide a video tag game in accordance with embodiments of the invention. A server computer 102 communicates via a network 124, e.g., the Internet, with one or more client computers. In one example, the video server 120 and database server 160 communicate with the server computer 102, via, for example, a secure network separated from the network 124, but, for security reasons, do not communicate with the client computers 130, 140, 150. Three client computers 130, 140, 150 are shown in this example, but any number of clients may participate in the game. Similarly, multiple servers may be present, e.g., to provide load balancing or fault tolerance, or to distribute resources or code across multiple servers. The database server 160 and video server 120 may be separate servers as shown, or may be located on the server computer 102.

The server computer 102 provides video tag server logic 104 that implements the game. In particular, the video tag server logic 104 includes video tag user interface logic 106 that implements a video tag game user interface, e.g., code in a language such as JavaScript™, Adobe® Flex™, Flash®, or the like, that is transmitted to the client computer(s). The video tag game user interface logic 106 causes a video tag game user interface 134 to be displayed on the client computer 130. A user 139 of the client computer 130 interacts with the user interface 134 to play the game. During the game, the video tag game user interface 130 displays, i.e., plays, one or more videos 120 on one or more displays 132, 142, 152 of client computers 130, 140, 150, and one or more users 139, 149, 159, provide tags, e.g., short text strings, based on the users' perception of the videos at particular points in time. The videos 120 may be any media object that is time-based, such as videos, movie trailers, television shows, advertisements, stock video footage, news videos, slide shows, vector graphics animations, and so on. The term “video” as used herein refers to any such time-based media object. In one example, a time-based media object varies with time and may be, for example, a human-perceivable visual image or sound that varies with time. Each client computer participating in the game, e.g., client computers 130, 140, and 150, displays a similar video tag game user interface 134, 144, 154 to a corresponding user 139, 149, 159. Note that although three client computers are shown in the example of FIG. 1, any number of client computers may participate in the game.

In one example, the video images displayed on each user interface 134, 144, 154 are synchronized or substantially synchronized, so that the videos begin playing at approximately the same time (or within a small difference of time, e.g., within 1 second or within 3 seconds of each other), and videos are displayed at approximately the same rate, e.g., within 5 or 10 frames per second of each other, or each frame is displayed at approximately the same time on each client computer 130, 140, 150, e.g., within 0.5 seconds or within 1 second of the time the same frame is displayed on each other client computer.

In one example the video tag server logic 104 may choose the video to be displayed in the game and control the start of the game by transmitting instructions to each client 130, 140, 150 to start the game. In another example, a game master, who may be a designated user, may choose the video and start of the game. The game master may start the game when at least two players (i.e., users) have joined. In one example, users are not permitted to play a game using a video from a game that they have previously played, to prevent prior knowledge from affecting the game. In another example, users may be permitted to play a subsequent game using the same video as a previous game. In one example, when the game is started, the video tag server logic 104 waits for a predetermined time period, e.g., 5 or 10 seconds, for players to become available to join the game. If at least one live, i.e., human, player is available, then the game is started. In one example, the minimum number of players is 4, and the maximum number of players is 8. If less than 4 live players are available, then “virtual” players may be added to the game to reach the minimum number of players. A virtual player is provided by the video tag server logic 104 using data from one or more previously-played games, referred to herein as prerecorded games. In one example, during a game, a virtual player enters tags selected from a previously-played (i.e., prerecorded) game at the same relative times as the tags were entered in the previous game. The relative times are relative to the beginning of the video. A virtual player may enter the same tags at essentially the same relative times as a previous live player in a prerecorded game, or a virtual player may enter a subset of the previous player's tags, or a combination of multiple previous players' tags from one or more prerecorded games.

In one example, a single user 139 may play the video tag game. The single-player game may be implemented by, for example, comparing the tags and associated times provided by the single user to a predefined set of tags and associated times for the video. The predefined tags and times may be derived from old games, for example.

In one example, the video tag user interface logic 106 causes the video(s) 122 to be displayed on the client computer(s) 130 continuously or substantially continuously, so that the user(s) 139 cannot stop or pause the display of the video(s) 122 without stopping the game.

In one example, the video(s) 122 are displayed on the display 132 of the client computer 130, and audio associated with the video is played by an audio output device 136, e.g., a speaker or headphones associated with the client computer 130. Therefore the tags provided by the users may be provided in response to the audio portion of the video, or in response to the visual portion of the video, or in response to both the audio and visual portions of the video. The user provides the tags via an input device 138 associated with the client computer 130. The input device 138 may be, for example, a keyboard, or any other device that allows a user to specify tags.

The database server 160 stores data in tables 162. The tables 162 represent entities in the video tag game, such as videos, games, users, associations of tags with videos, and game scores, as described in more detail below. The video server 120 stores and provides videos 122 for display on the client computer(s) 130.

The video tag server logic 104 also includes tag processing logic 108, which receives tags and performs appropriate actions, such as awarding consideration, e.g., points, to the user who submitted the tag, and associating the tag with the video 122. The tag processing logic 108 includes tag association logic 112, which associates the tag with the video 122 that the user 139 was viewing when the tag was submitted. The time at which the user 139 submitted the tag may also be associated with the tag and the video 122. The time may be expressed as a number of seconds since the beginning of the video, or as an absolute time since some epoch, e.g., Jan. 1, 1970, along with an absolute time at which the video began playing in the display 132.

The tag processing logic 108 includes scoring logic 110, which determines a number of points to award to a user 139 in response to receiving a tag from the user 139 and a time at which the tag was provided, i.e., submitted, by the user to the client computer 130 via the input device 138. The video tag game provides incentives, e.g., points or other consideration, to user(s) who provide tags, to motivate the users to provide accurate or appropriate tags. The consideration may take the form of an award of points, an online payment, a credit toward future purchases, or the like, or any other act. The act of placing the user's score in a public area such as a publicly-viewable high scores list may be a form of consideration, since players may value the social credit or fame that they receive from performing well in the game.

The amount of consideration, e.g., the number of points, amount of payment, or other amount of value, may be based upon the time at which the user 139 provided the tag, upon the tag itself, and upon similarities or differences between the tags provided by different users, e.g., the difference in time between user A 139 providing a tag and user B 149 providing the same tag for the same video. In this example, the quantity of points awarded to a player by the scoring logic 110 is inversely proportional to the time difference, i.e., time window, between a first player entering the tag and a second player entering the tag. In one example, points are awarded to the first player and the second player if the time difference is less than a threshold value. The number of points awarded may vary based upon the time difference. For example, multiple ranges may be defined, e.g., a time difference of 0-2 seconds results in an award of 30 points, a time difference of 2-5 seconds results in an award of 20 points, and a time difference of 5-10 seconds results in an award of 10 points. In another example, a formula may be used, e.g., if the time difference is less than a threshold value such as 15 seconds, the number of points awarded is determined by a formula such as a predetermined value, e.g., 15, divided by the time difference, if the time difference is between 0.1 and 15 seconds, and a predetermined value, e.g., 300, if the time difference is 0 to 0.1 seconds.

In one example, the scoring logic 110 may enforce a tag repeat time interval, so that a user who enters two tags within the tag repeat time interval, e.g., 10 seconds, will not receive points for the second and successive tags entered within the tag repeat time interval of the first tag.

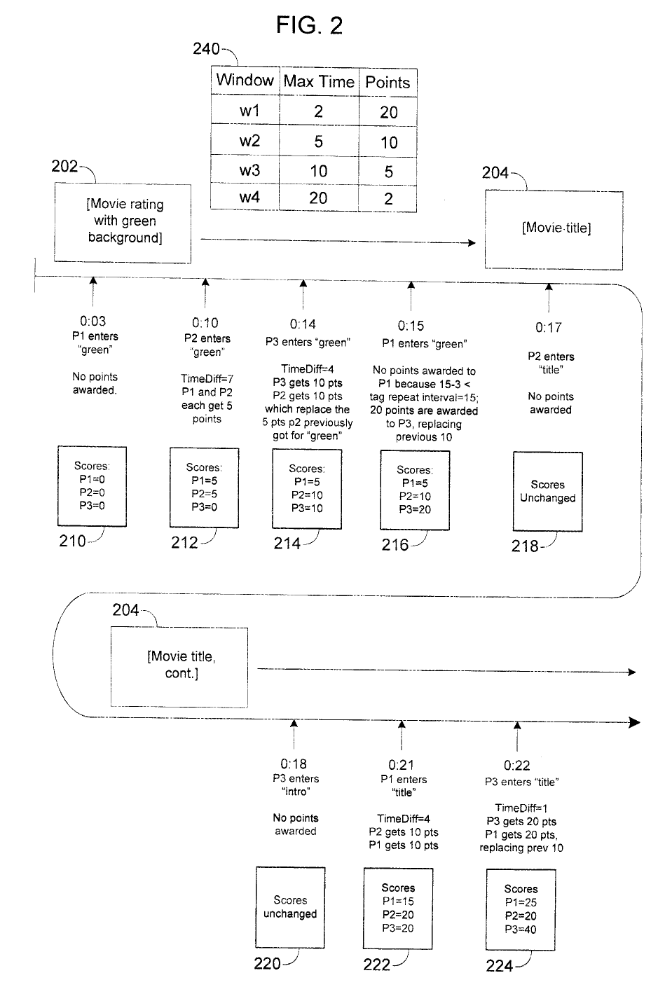

FIG. 2 illustrates allocation of points to players in response to receipt of tags for a video in accordance with embodiments of the invention. In the example of FIG. 2, a movie is displayed, and tags are received from three players, player P1, player P2, and player P3, as time passes and the movie progresses. Points are awarded to the players based upon the scoring windows shown in table 240. Specifically, if the time difference between receiving a tag from two different players falls within a first window, w1, of 2 seconds, then 20 points will be awarded to each of the two players. If the time difference falls within a second window, w2, of 5 seconds, then 10 points will be awarded to each of the two players. If the time difference falls within a third window, w3, of 10 seconds, then 5 points will be awarded to each of the two players. If the time difference falls within a fourth window, w4, of 20 seconds, then two points will be awarded to each of the players. In one example, each player is awarded points from the smallest time window in which the time difference falls, but not from any larger time windows above the smallest time window.

The example of FIG. 2 begins with a movie 202 being displayed to each of the three users. The initial frames of the movie display rating information for the movie with a green background, from time 0:00 seconds to time 0:17 seconds. At time 0:17 seconds, a movie title 204 is displayed in place of the movie rating. The movie title may be displayed as part of a scene involving other displayed features such as scenery or actors, and the appearance of the movie title may change with time. The movie title is displayed for the remaining time shown in this example, until after 0:22 seconds.

Once the movie title has appeared on player P1's display, P1 enters the tag “green” and the tag is received (e.g., by the tag processing logic 108 of FIG. 1) at time 0:03 seconds. Note that the time at which a tag is received or entered may be the time at which the user entered, i.e., typed, the tag, or the time at which the tag was received, which may be later. In this example, the time at which the tag is entered or received is the time at which the tag is received by the server 102. In other examples, any time measurement point may be selected as the tag time, but the same measurement point should be used for all tags in the game.

Since points are awarded in this example game based upon proximity in time of different users' entries of the same tag, no points are awarded for P1's entry at 0:03 seconds, because no other tags have been received yet. Therefore, the scores 210 of all three players are 0 at time 0:03 seconds.

Next, player P2 enters the tag “green” at 0:10 seconds. For each tag received, the scoring logic 110 of FIG. 1 calculates the time difference between two entries of the same tag by different players, and awards points to the players who entered the tag if the difference falls into one of the time windows defined in the table 240. Since P2 entered “green” at 0:10 seconds, the time difference between P2's entry of green and P1's entry of green is 0:10−0:03=0:07 seconds, which falls into the third window, w3, because it is less than 10 but greater than 5. Therefore, P2 and P1 each get 5 points for entering the tag “green” within 7 seconds of each other. The scores 212 show that P1 and P2 now have 5 points each, and P3 has zero points.

At time 0:14, P3 enters the tag “green”. For P3, the time difference between P3's entry of green and P2's entry of green is 4 seconds, which falls into w2, and w2's associated points value is 10. Therefore, both P3 and P2 get 10 points. However, P2 previously got 5 points for entering “green”. In one example, a single points award is made for each tag, and the single points award is for the maximum point award for which the player qualifies, so P2's existing 5 point score is changed to 10 points, since the existing 5 points were for the same tag (“green”). For P3 and P1, the time difference is 11 seconds, which falls into w4. Since P1 already received 5 points for entering “green”, and a single points award is made for each tag, P1, and 5 points is greater than the 2 points that P1 would receive for an 11 second time difference, P1's score remains at 5 points. The scores 214 show that P1 now has 5 points, P2 has 10 points, and P3 has 10 points.

At time 0:15 seconds, P1 enters the tag “green” again. No points are awarded to P1 because the time difference between P1's first and second entries of the same tag (15−3=12 seconds) is less than the tag repeat interval, which is 15 seconds in this example. Since P3 entered the same tag at time 0:14, and the time difference is 1 second, P3 now qualifies for the 20 point award of window wt. Therefore, P3's score is increased by the difference between the previous point value awarded for the tag green (10) and the new point value for the tag green (20). P3's new score is thus 20. In this example, the possible awarding of points to other users when a user enters a tag before the tag repeat time interval has elapsed serves to discourage users from entering the same tag repeatedly within a short time interval. The scores 216 show that P1 still has 5 points, P2 still has 10 points, and P3 now has 20 points.

At time 0:17 seconds, P2 enters the tag “title”. No points are awarded because no other player has previously entered “title”, and the scores 218 remain unchanged.

At time 0:18 seconds, P3 enters the tag “intro”. Again, no points are awarded because no other player has previously entered “intro”, and the scores 220 remain unchanged.

At time 0:21 seconds, P1 enters the tag “title”. The time difference between P1's entry of “title” and P2's entry of “title” is 4 seconds (21−17), which falls into the window w2 associated with 10 points, so P1 and P2 are each awarded 10 points. The scores 222 are P1=15 points, P2=20 points, and P3=20 points.

At time 0:22 seconds, P3 enters the tag “title”. The time difference between P3's entry of “title” and P1's entry of “title” is 1 seconds, which falls into the window w1 associated with 20 points. Therefore, P3 and P1 are each awarded 20 points for their entry of “title”. However, P1 has previously received 10 points for “title”, so P1's score is only increased by the difference between the higher and lower point values (20−10=10). P3's score is increased by the full 20 points. P2 has previously entered “title” at time 0:17, for which the time difference from P3's entry is 5 seconds, which corresponds to 10 points. However, P2 was previously awarded 10 points for “title” at time 0:21, so no additional points are awarded to P2. The final scores 224 in this example are P1=25, P2=20, and P3=40 points.

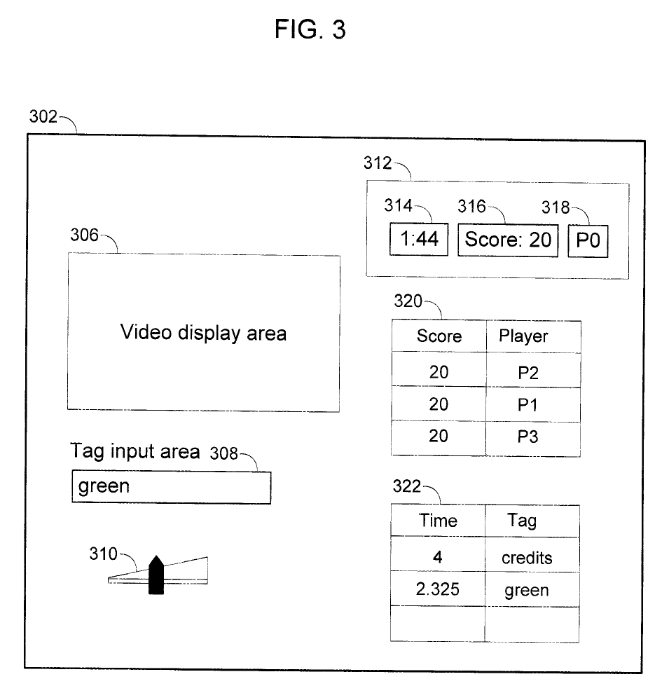

FIG. 3 illustrates a video tag game user interface 302 in accordance with embodiments of the invention. The video tag game user interface 302 corresponds to the video tag game user interfaces 134, 144, 154 of FIG. 1, and is displayed on one or more devices such as client computers 130, 140, 150. The video tag game user interface 302 may also be displayed on mobile devices such as cellular phones, personal digital assistants, or other devices with the capability to provide the features of the interface 302. The interface may be provided by, for example, computer program code (i.e., instructions) that is executable on the client computer 130 or other device, such as HTML, Java®, JavaScript™, Adobe® Flash®, or the like. The code or instructions may be provided to the client computer 130 or other device by a server, such as the server 102 of FIG. 1.

In one example, the video tag game user interface 302 includes user interface components, e.g., widgets, controls, or other types of user interface features, including a video display component 306, a tag entry component 308, a volume control 310, a player status area 312, a score display component 320, and a tag table 322. The components may be implemented using computer program code that performs actions based on the user's interactions with the components. As described above, in one example, the components are provided to the client 130 (and to other clients, if present, e.g., client 140 and client 150) by the server 102. The components of the video tag game user interface 134 may be displayed by a web browser or other software application running on each client computer 130.

In one example, the video tag game user interface 302 displays a video in the video display component 306 using, for example, an Apple® QuickTime® plug-in in the web browser. The video display component 306 displays a video in real-time or near-real time, where the video may be provided in the form of a file and displayed at a specified frame rate for a specified duration of time. The frame rate and duration of time may be specified in the video file, or may be specified in a database table or other data structure. In one example, the video display component 306 displays the video continuously or substantially continuously, so that a user cannot pause and resume the video and continue to participate in the video tag game. In another example, the user may pause and resume the video during the video tag game, but in other examples, the user may not enter tags while the video is paused, and the video may fast-forward or jump to a later point to catch up with the other players when the user resumes the video.

The tag entry component 308 may be, for example, a text input area that receives a string, e.g., “green”, or other representation of a tag from the user. The tag, and, optionally, the time at which the tag was received, may be transmitted to the server computer 102 via the network 124 for processing by the video tag server logic 104. The volume control 310 is, for example, a slider control, which a user can adjust to control the volume of the audio portion of the video.

The player status area 312 includes an elapsed time timer 314, which displays the amount of time that has elapsed in the current game, if a game is currently being played via the user interface 302. The player status area 312 also includes a current score display 316, which displays the score of the user of the user interface 302, and a player name 318, which displays a player name that identifies the user of the user interface 302.

The score display component 320 displays the scores of the players participating in the current or most recent video tag game. In this example, the score display component 320 indicates that P1, P2, and P3 each have a score of 20 points. Some of the scores to be displayed in the score display component 320 may be generated by the scoring logic 110, which may be located on the server 102, or on the client computer(s) 130 in a distributed fashion. For example, when a tag is received in the tag input area 308 by a client computer 130, the client computer 130 may transmit the tag to the server 102, which may then compute the resulting score(s) for each user. The timestamp associated with the tag is included in the calculation as described above with respect to FIG. 2. The timestamp may be determined by the client computer 130 that receives the tag, or by the server computer 102 upon receiving the tag from the client computer 130. In one example, the client computer 130 determines the timestamp based upon the value of a clock associated with the client computer 130 when the tag is received. The timestamp is then transmitted to the server 102 with the tag, and the server 102 determines the score using the scoring logic 110. The server 102 then transmits the updated scores to the client computer(s) 130, which display the scores in the score display component 320. In this example, the scores are based upon the time at which the tags were received by the client computer(s) 130. In another example, as indicated above, the scores may be based upon the time at which the tags are received by the server 102 from the client computer(s) 130. In both examples, the scores are based upon the time at which the tags are received by a computer, i.e., upon a timestamp associated with the tag, where the timestamp indicates the time at which the tag was received.

In one example, the tag table 322 displays the tags recently received from players participating in the current or most recent video tag game. The tag table 322 may be generated based upon tag values received from the server 102, similar to the way the score display component displays scores, as described above. In this example, the tag table 322 indicates that the tag “green” was received at time 2.325 seconds, and the tag “credits” was received at time 4 seconds.

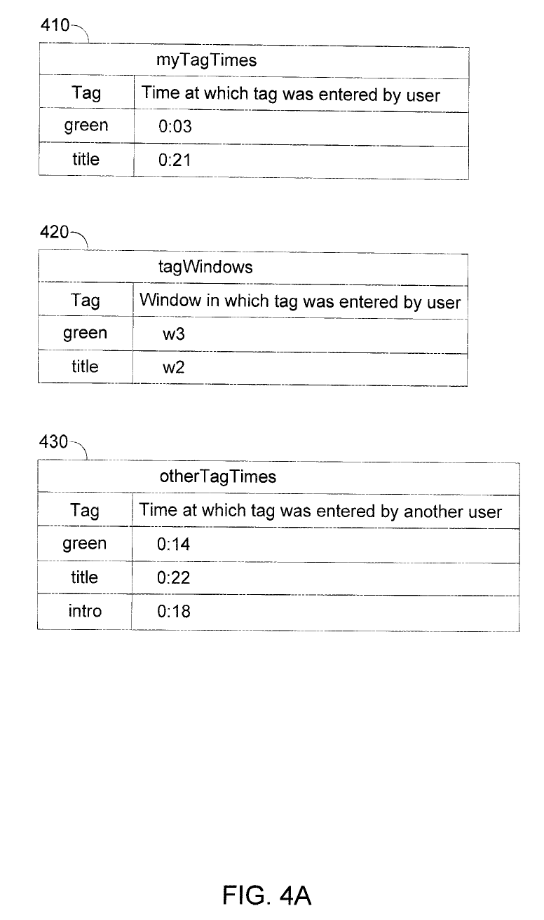

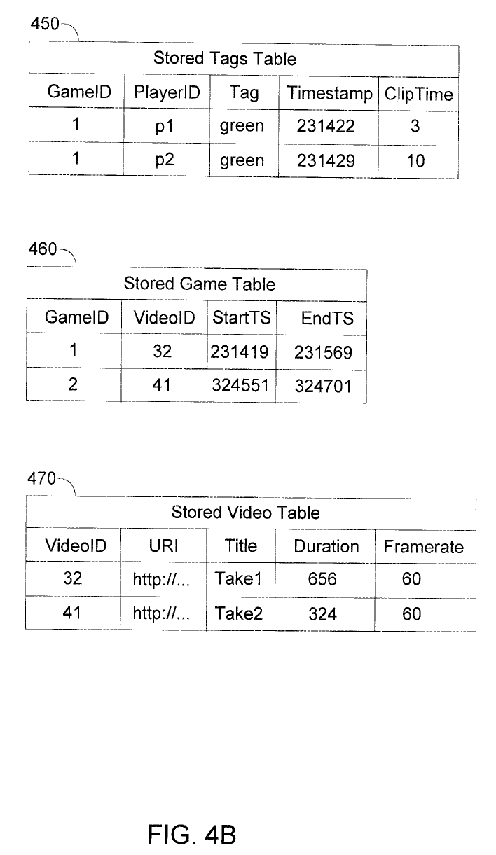

FIGS. 4A and 4B illustrate data structures for use in a video tag game in accordance with embodiments of the invention. FIG. 4A shows data structures that relate to the scoring mechanism and are used as lookup tables and are stored in internal, i.e., random-access computer memory in one example, although the data structures of FIG. 4A may be stored in any form of memory. A myTagTimes table 410 stores one or more (tag, time) pairs, where the time is the time at which the tag was entered by the user with whom the table is associated. For example, the first row of the table specifies that the tag “green” was entered by the user at time 0:03 seconds. An entry in the myTagTimes table 410 indicates that the user with whom the table is associated entered the tag at the associated time.

A tagwindows table 420 stores one or more (tag, window) pairs, e.g., (“green”, w3). For example, the first row of the table specifies that, for the current user, the tag “green” is associated with window w3. An entry in the tagwindows table 420 indicates that the user entered that tag in the specified time window. The tagwindows table 420 may be used, for example, to determine how many points the user should be awarded the second and subsequent times that the user is eligible to receive points for the same tag.

An otherTagTimes table 430 stores one or more (tag, time) pairs, where the time is the time at which the tag was entered by another user. That is, for each user, a myTagTimes table 410 is maintained that includes the tags entered by that user, and an otherTagTimes table 430 is maintained that stores the tags entered by other users. The otherTagTimes table 430 may be used, for example, to determine if the user's score should be updated to reflect a tag added by another user.

FIG. 4B shows data structures that are stored in a relational database in one example, although the data structures of FIG. 4B may be stored in any form of memory. A stored tags table 450 stores the tags and timestamps (and corresponding clip time, the time relative to the beginning of the video). The player who entered each tag is also stored along with the tag. The stored tags table 450 represents the results of the video tag game, i.e., the tag values and the times at which the tags were received or entered).

A stored game table 460 stores a game identifier, an associated video identifier, and a start timestamp and end timestamp. The video identifier identifies the video for the game. A stored video table 470 stores information for locating and playing videos, such as a URI (Uniform Resource Identifier) for each video, which specifies an address or location from which the video may be retrieved. The stored video table 370 also stores the title, duration, and frame rate associated with each video, and any other metadata associated with the video.

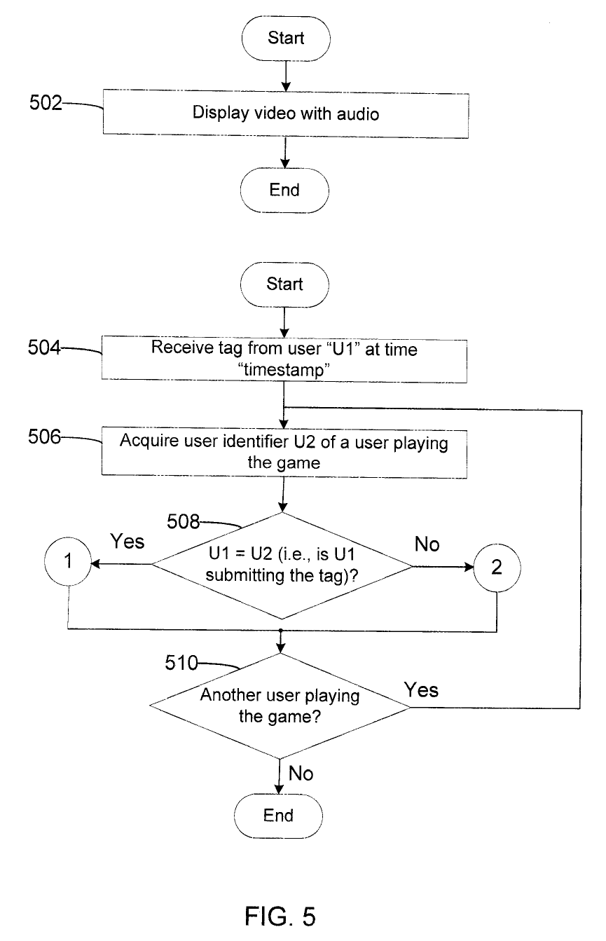

FIG. 5 illustrates a process for allocating points to users in response to receipt of tags in accordance with embodiments of the invention. Block 502 causes the video to be displayed to a user, e.g., by transmitting the video as a stream or video file to the client browser of each user. In one example, the video is displayed on the client browser continuously, i.e., as a continuous stream of images that cannot be paused by the user without terminating the game. In one example, small pauses in video display caused by factors beyond the user's control, such as network delays or congestion, may be tolerated, and the game may continue, or the user may be given an option to halt the game. Therefore the video is displayed on the client computers substantially continuously, e.g., at a target frame rate for 90% of the video's duration, or with delays no greater than a predetermined time limit, or any combination thereof, or using any means for evaluating the progress of the video display and stopping the game if the display rate does not meet a particular desired rate. In one example, block 502 causes the video to be executed by instructing a client to display the video. The client then displays the video continuously, e.g., streaming from the video server 120 of FIG. 1, until the end of the video or until a predetermined time limit is reached. In one example, the time limit is 2 minutes and 30 seconds. When the time limit is reached, the game terminates and player scores are displayed. In another example, block 502 executes concurrently on the server 102 with the remaining blocks (504-510) of FIG. 5, to display the video while the tags are being received and processed.

In one example, a sequential order is imposed on tags being entered, e.g., by passing all tags through a single control or synchronization point on the server, or by associating timestamps or clock values with tags. The tags are then received and processed in the defined order at block 504. Block 504 receives each tag. Each tag is received from a user, identified here as “U1”, at a time identified here as “timestamp”.

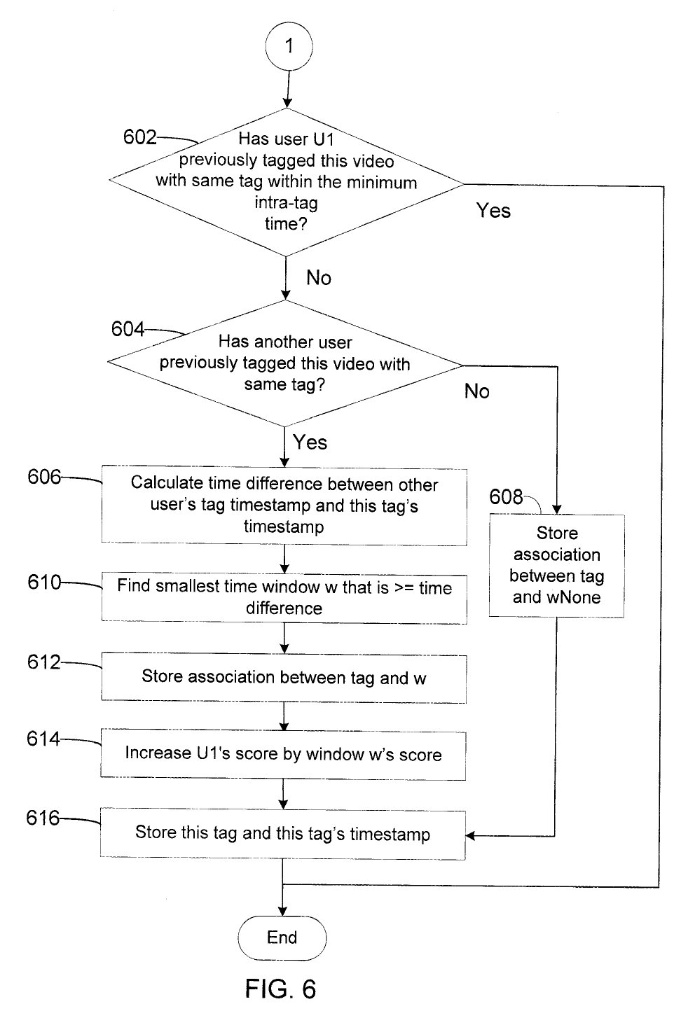

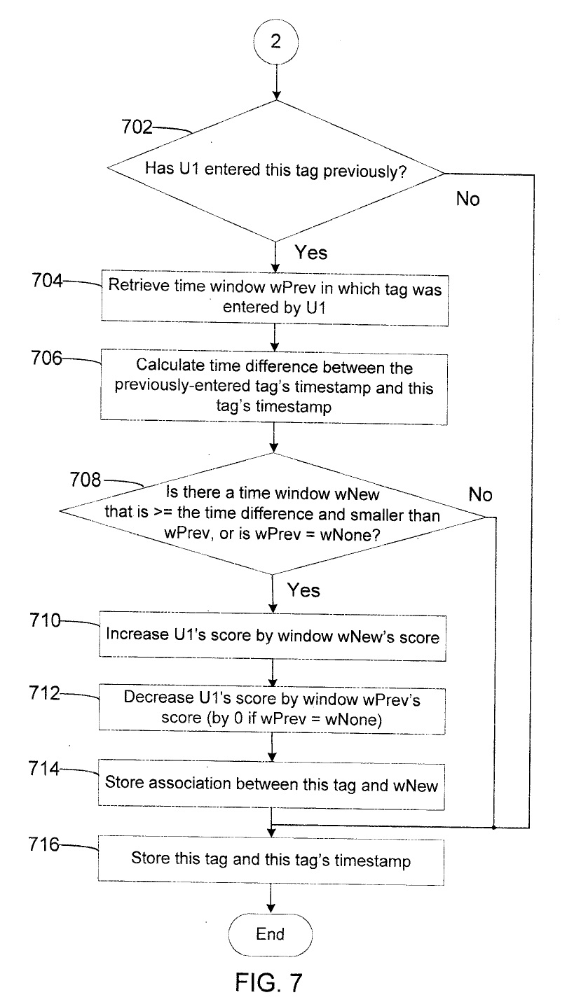

When a tag, referred to herein as “this tag”, is entered by any user at a given time-stamp, the process of FIG. 5 iterates over the users playing the game to check if each user's score is to be updated based on the newly received tag. For each user U2, block 506 identifies user U2, and block 508 determines if U2 is the same as the user U1 submitting this particular tag. If so, the process of FIG. 6 is invoked, as shown by the circled number 1, to add this tag to user U1's myTagTimes table and to allocate points to U1. Otherwise, another user U2 has added a tag equal to this tag, and the process of FIG. 7 is invoked, as shown by the circled number 2, to update U1's score based on the tag added by U2, and to add this tag to U1's otherTagTimes table. The tag added by U2 may increase U1's score if U1 has previously submitted the same tag within a sufficiently small window of time. After the process of FIG. 6 or FIG. 7 has been invoked and completed, block 510 determines if there is another user playing the game, and if so, transfers control to block 506 to process the next user as a new value for U2. If there are no further users to process, the flowchart ends.

FIG. 6 illustrates a process for allocating points to a user in response to receipt of a tag from the user in accordance with embodiments of the invention. The process of FIG. 6 is executed when the user executing the process of FIG. 5 has entered this tag. Block 602 enforces the minimum tag time interval by determining if the user U1 (i.e., the user who entered this tag), has previously entered the same tag within the minimum intra-tag time. If so, the process completes and control returns to FIG. 5. If the minimum tag time interval has not been violated, block 604 determines if another user has previously entered the same tag for this video. In one example, block 604 may search the otherTagTimes table for the tag. If no other user has previously entered the tag for this video, an association between the tag and a special time window, referred to herein as “wNone”, is created at block 608, to indicate that U1 has entered the tag, but that there is no defined time window, because no other user has entered the tag and a time difference cannot be calculated. The tag-wNone association is stored in, for example, a tagWindows table associated with user U1. Block 616 then stores the tag and the tag's timestamp in, for example, a myTagTimes table. Example tagWindows and myTagTimes tables are illustrated in FIG. 4A.

If block 604 determines that another user has previously entered the same tag for this video, the block 606 calculates the time difference between the timestamp of the tag entered by the other user and the timestamp of U1's tag. Block 610 finds the smallest time window w that is greater than or equal to the time difference. In one example, block 610 may search a table of time windows such as the table 240 of FIG. 2.

In other examples, a formula or other analytical method may be used instead of the time window technique to calculate the score. For example, a formula may be used, or the inverse of the time difference may be used as the score, or the score may be based upon additional information, such as image recognition or image processing results from the video. For example, if an image processing technique indicates that a face is present in the video at the time the tag was received, and the tag is related to the word “face”, then a predetermined point value may be awarded to the user(s) who enter the tag. Similarly, a dictionary of synonyms may be used, and points or consideration may be awarded to two or more users who enter words that are synonyms of each other.

Block 612 stores an association between the tag and the time window w found in block 610. The association may be stored, for example, in the tagWindows table associated with U1, replacing any previous entry for the same tag. Block 614 increases U1's score by the score value associated with window w (e.g., by the value from the “Points” column of the table 240). Block 616 stores the tag and the tag's timestamp, as described above.

FIG. 7 illustrates a process for allocating points to a user in response to receipt of a tag from another user in accordance with embodiments of the invention. The process of FIG. 7 is invoked when another user (other than the user executing the process of FIG. 5) has entered this tag. Block 702 determines if user U1 (the user executing the process of FIG. 5) has previously entered the same tag. In one example, block 702 may search the myTagTimes table for the tag. If not, control transfers to block 716, which stores this tag and this tag's timestamp. In one example, block 716 may store the tag and timestamp in the otherTagTimes table 430 of FIG. 4A. The flowchart then ends and control transfers back to the flowchart of FIG. 5.

If block 702 determines that user U1 has previously entered the same tag (e.g., the tag was found in the myTagTimes table), then block 704 retrieves the time window, referred to herein as “wPrev”, in which the tag was entered by U1. Block 706 calculates the time difference between the previously-entered tag's timestamp and this tag's timestamp. Block 708 enforces the rule that each player receives the maximum possible score for each tag match by determining if there is a time window, referred to herein as “wNew”, that is greater than or equal to the time difference and smaller than wPrev, or, alternatively, if wPrev is equal to wNone. If not, then control transfers to block 716, which stores this tag and its associated timestamp as described above. If there is a wNew time window, or if wPrev is equal to wNone (i.e., any time window would be smaller than wPrev, since wPrev is not defined), then block 708 transfers control to block 710, which increases U1's score by the score value associated with the window wNew. Block 712 enforces the rule that each player receives credit at most once for each tag by reducing U1's score by the score associated with window wPrev, if wPrev is not equal to wNone. If wPrev is equal to wNone, then U1 did not previously receive credit for the tag, and U1's score is not reduced. Block 714 stores an association between this tag and wNew, e.g., in the tagwindows table. Block 716 stores this tag and associated timestamp, as described above. As described above, the window scoring technique is one example of allocating scores based on time differences, and different techniques are possible and contemplated.

While the invention has been described in terms of particular embodiments and illustrative figures, those of ordinary skill in the art will recognize that the invention is not limited to the embodiments or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable media. Some other processes can be implemented using analog circuitry, as is well known to one of ordinary skill in the art. Additionally, memory or other storage, as well as communication components, may be employed in embodiments of the invention.

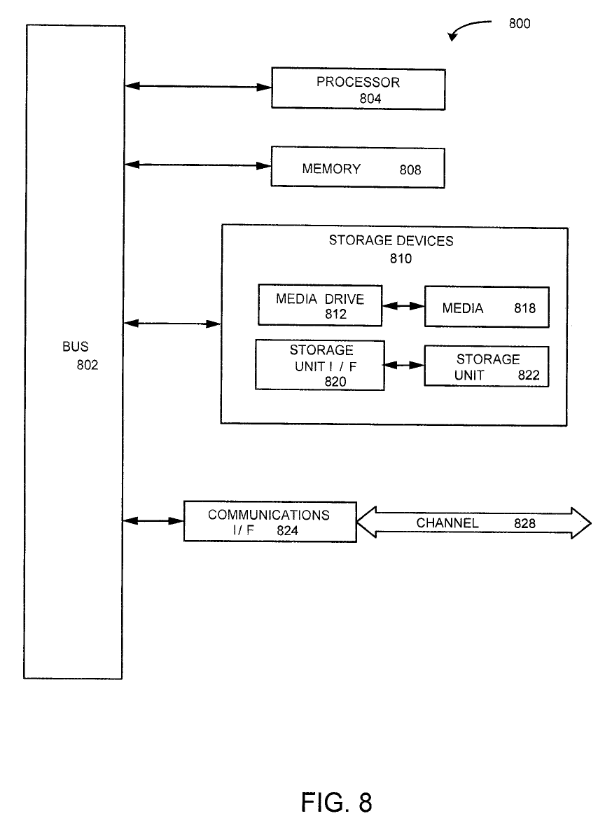

FIG. 8 illustrates a typical computing system 800 that may be employed to implement processing functionality in embodiments of the invention. Computing systems of this type may be used in clients and servers, for example. Those skilled in the relevant art will also recognize how to implement the invention using other computer systems or architectures. Computing system 800 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 800 can include one or more processors, such as a processor 804. Processor 804 can be implemented using a general or special purpose processing engine such as, for example, a microprocessor, microcontroller or other control logic. In this example, processor 804 is connected to a bus 802 or other communication medium.

Computing system 800 can also include a main memory 808, such as random access memory (RAM) or other dynamic memory, for storing information and instructions to be executed by processor 804. Main memory 808 also may be used for storing temporary variables or other intermediate information during execution of instructions to be executed by processor 804. Computing system 800 may likewise include a read only memory (“ROM”) or other static storage device coupled to bus 802 for storing static information and instructions for processor 804.

The computing system 800 may also include information storage system 810, which may include, for example, a media drive 812 and a removable storage interface 820. The media drive 812 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 818, may include, for example, a hard disk, floppy disk, magnetic tape, optical disk, CD or DVD, or other fixed or removable medium that is read by and written to by media drive 814. As these examples illustrate, the storage media 818 may include a computer-readable storage medium having stored therein particular computer software or data.

In alternative embodiments, information storage system 810 may include other similar components for allowing computer programs or other instructions or data to be loaded into computing system 800. Such components may include, for example, a removable storage unit 822 and an interface 820, such as a program cartridge and cartridge interface, a removable memory (for example, a flash memory or other removable memory module) and memory slot, and other removable storage units 822 and interfaces 820 that allow software and data to be transferred from the removable storage unit 818 to computing system 800.

Computing system 800 can also include a communications interface 824. Communications interface 824 can be used to allow software and data to be transferred between computing system 800 and external devices. Examples of communications interface 824 can include a modem, a network interface (such as an Ethernet or other NIC card), a communications port (such as for example, a USB port), a PCMCIA slot and card, etc. Software and data transferred via communications interface 824 are in the form of signals which can be electronic, electromagnetic, optical or other signals capable of being received by communications interface 824. These signals are provided to communications interface 824 via a channel 828. This channel 828 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product,” “computer-readable medium” and the like may be used generally to refer to media such as, for example, memory 808, storage device 818, or storage unit 822. These and other forms of computer-readable media may be involved in storing one or more instructions for use by processor 804, to cause the processor to perform specified operations. Such instructions, generally referred to as “computer program code” (which may be grouped in the form of computer programs or other groupings), when executed, enable the computing system 800 to perform features or functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 800 using, for example, removable storage drive 814, drive 812 or communications interface 824. The control logic (in this example, software instructions or computer program code), when executed by the processor 804, causes the processor 804 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Moreover, it will be appreciated that various modifications and alterations may be made by those skilled in the art without departing from the spirit and scope of the invention. The invention is not to be limited by the foregoing illustrative details, but is to be defined according to the claims.

Although only certain exemplary embodiments have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. A computer-enabled method of labeling at least one portion of a video, the method comprising:
causing the video to be displayed to at least two users, including a first user and a second user;
receiving a first tag from the first user, wherein the first tag is received at a first time;
receiving a second tag from the second user, wherein the second tag is received at a second time;
determining a time difference between the first time and the second time;
associating the first tag with the video; and
providing a first consideration to the first user in response to the first tag matching the second tag and the time difference being less than a predetermined value, wherein the first consideration is based upon the time difference.

2. The method of claim 1, wherein associating the first tag with the video comprises storing an association among the video, the first tag, and the first time.

3. The method of claim 1, further comprising associating the second tag with the video.

4. The method of claim 1, wherein the first consideration comprises a first quantity of units of value, and the first quantity is based upon the time difference.

5. The method of claim 1, wherein providing the first consideration comprises increasing a score associated with the first user by a quantity of points, wherein the quantity is based upon the time difference.

6. The method of claim 1, wherein the first consideration is inversely proportional to the time difference.

7. The method of claim 1, further comprising:
providing a second consideration to the second user in response to the first tag matching the second tag and the time difference being less than the predetermined value, wherein the second consideration is based upon the time difference.

8. The method of claim 7, wherein the second consideration is inversely proportional to the time difference.

9. The method of claim 1, further comprising:
enforcing a tag repeat interval, wherein the first quantity is not provided to the first user if the first tag has been received from the first user at a previous time and the difference between the first time and the previous time is less than the tag repeat interval.

10. The method of claim 1, wherein causing the video to be displayed comprises causing the video to be displayed substantially continuously for a predetermined period of time.

11. The method of claim 1, wherein the video comprises a time-based media object.

12. A computer-enabled method of labeling at least one portion of a video, the method comprising:
causing the video to be displayed to a user, wherein the video is associated with at least one prerecorded tag, wherein the at least one prerecorded tag is obtained from a previously-recorded game;
receiving a first tag from the user, wherein the first tag is received at a first time;
selecting a second tag from the at least one prerecorded tag, wherein the second tag matches the first tag, the second tag is associated with a second time;
determining a time difference between the first time and the second time;
associating the first tag with the video; and
providing a first consideration to the user in response to the time difference being less than a predetermined value, wherein the consideration is based upon the time difference.

13. An interface for labeling at least one portion of a video, the interface comprising:
a video display component for displaying the video, wherein the video is received from a server;
a tag entry component for receiving at least one tag from a user, wherein the interface is operable to transmit the at least one tag to the server; and
a score display component for displaying a score received from the server, wherein the score is associated with the user, the score is based upon at least the at least one tag and a timestamp associated with the at least one tag, and the timestamp indicates a time of receipt of the at least one tag.

14. A computer-readable medium comprising instructions for labeling at least one portion of a video, the instructions for:
causing the video to be displayed to at least two users, including a first user and a second user;
receiving at least two tags from the at least two users, including a first tag and a second tag,
wherein the first tag is received at a first time, and the second tag is received at a second time;
determining a time difference between the first time and the second time;
associating the at least two tags with the video; and
providing a first consideration to the first user in response to the first tag matching the second tag and the time difference being less than a predetermined value, wherein the first consideration is based upon the time difference.

15. The computer-readable medium of claim 14, wherein associating the at least two tags with the video comprises storing an association between the video, the first tag, and the first time, and storing an association between the video, the second tag, and the second time.

16. The computer-readable medium of claim 14, wherein the first consideration comprises a first quantity of units of value, and the first quantity is based upon the time difference.

17. The computer-readable medium of claim 14, wherein the first consideration is inversely proportional to the time difference.

18. The computer-readable medium of claim 14, further comprising instructions for providing a second consideration to the second user in response to the first tag matching the second tag and the time difference being less than the predetermined value, wherein the second consideration is based upon the time difference.

19. An apparatus for labeling at least one portion of a video, wherein the apparatus is located at a server on a network, the apparatus comprising:
logic for causing the video to be displayed to at least two users, including a first user and a second user;
logic for receiving a first tag from the first user, wherein the first tag is received at a first time;
logic for receiving a second tag from the second user, wherein the second tag is received at a second time;
logic for determining a time difference between the first time and the second time;
logic for associating the first tag with the video; and
logic for providing a first consideration to the first user in response to the first tag matching the second tag and the time difference being less than a predetermined value, wherein the first consideration is based upon the time difference.

20. The apparatus of claim 19, wherein the logic for associating the first tag with the video is further operable to store an association among the video, the first tag, and the first time.

21. The apparatus of claim 19, further comprising logic for associating the second tag with the video.

22. The apparatus of claim 19, wherein the first consideration comprises a first quantity of units of value, and the first quantity is based upon the time difference.

23. The apparatus of claim 19, wherein the logic for providing the first consideration is operable to increase a score associated with the first user by a quantity of points, wherein the quantity is based upon the time difference.

24. The apparatus of claim 19, wherein the first consideration is inversely proportional to the time difference.
